(19) United States
(12) Patent Application Publication
(10) Pub. No.: US 2025/0268416 A1
(43) Pub. Date: Aug. 28, 2025

(54) Alternating Process Wrist Strap-Internal Maneuver Concatenation Transverse Loop -Magnet Actuator Mixer Rotational Flavored Disperser Pods-Ring-Synchronize Mobile Devices

(71) Applicant: Maluki C Takumah, Atlanta, GA (US)

(72) Inventor: Maluki C Takumah, Atlanta, GA (US)

(21) Appl. No.: 18/590,742

(22) Filed: Feb. 28, 2024

(51) Int. Cl. A47J 31/52; A47J 31/40; B01F 23/50; B01F 33/453; B01F 33/501

(52) U.S. Cl. CPC A47J 31/52; A47J 31/407; B01F 23/56; B01F 33/453; B01F 33/5011; B01F 33/5014

(57) ABSTRACT

An unconventional beverage accessories submerged in cold or hot drinks can be operated by a button through apps on the smartphone and a ring. That can be strapped on any beverage container and controlled in sync with an apps smart phone. The Alternating Process Wrist Strap-Internal Maneuver Concatenation Loop Transverse-Magnet Actuator Mixer Rotational Flavored Disperser Pods and Ring-Synchronize Mobile Devices. This invention was created in the beverage sector to disperse flavors and mix up liquid with added supplements settlements, and to break boredom in traditional primitives' practices in everyday enjoyment of beverages. The new invention help add structure, advancement in modern society. The new invention is a Alternating Process Wrist Strap-Internal Concatenation Loop Transverse-Magnet Actuator Mixer Rotational Flavored Disperser Pods & Ring-Sync Mobile Devices. This invention is designed for a person's convenience and lifestyle with health conscious, environmental conscious and advanced new beverage concepts.

This new invention is designed to help prevent messy spotty clutter on tables etc. This present invention is also designed to take control with a push of a button.

### TECHNICAL FIELD

The main important features on the invention are the Internal Maneuver Concatenation Loop Transverse, and how

[symbol]

Concatenation Loop Transverse operated in tight cavity along the Wrist Strap/Belt.

This internal part of the wrist band/strap called Maneuver Concatenation Loop Transverse are very pivotal on its unique effective powered by small dc stepper sync motor rolls side to side on sprocket gears. The sprocket holes are catch by sprocket gear's teeth designed to Maneuver loop mechanism together with series of components.

The present invention related purposes to release flavors supplement extract from its Magnet Actuator Mixer Rotational Flavored Disperser Pods fibers.

This present invention is manual maneuver by a ring & hand or smartphone. In this application, the following terms will be understood to have the [symbol] indicated definitions:
Sync technology—this present invention is unconventional and need a new social practice for Wrist Strap/Band- [symbol]
Loop Transverse—Magnet Actuator Mixer Rotational Flavored Disperser Pods and Ring-Synchronize Mobile Devices form [symbol] all around the present invention.

Concatenation structure designed to manipulate back and forth movement force-this new invention is made with series [symbol] of mini components in its small encasement follow by a working time watch.

Sync technology can be customized with small/micro motors to integrate into your own unique designed application. Both hardware components and software Applications can be manipulated in high precision with miniature and micro drive systems technology. The watch base is within its encasement housing similar to a typical match box or a big oversize watch.

The Sync provides hands-free connectivity to your compatible, Bluetooth enabled phone, giving you the ability to [symbol] make calls, and direct the Magnet Actuator Mixer Rotational Flavored Disperser Pods by access on apps.

This application is a NON-Provisional Patent Application, filed Feb. 29, 2024.

### BRIEF DESCRIPTION OF THE DRAWINGS

FIG. 1A-1J. enlarged views and perspective of the Alternating Process Wrist Strap-Internal Maneuver Concatenation Loop Transverse-Magnet Actuator Mixer Rotational Flavored Disperser Pods and Ring-Synchronize Mobile Devices. The Alternating Wrist Strap-Belt indicates radiograph (x-ray) vision enclosed illustration on how the Alternating Strap-Belt wraps the beverage container. The Alternating Wrist Strap-Belt indicates some of its separate internal working component parts.

FIG. 2A-2G. enlarged view of The Alternating Wrist Process Strap. The Alternating Wrist Process Strap-Belt/Band are exposed support spaced notches which illustrate along its Band's length form. A complete radiograph (x-ray) vision of the Alternating Wrist Process Strap-Belt/Band.

FIG. 3A-3C. enlarged view of The Alternating Wrist Process Strap-Internal Maneuver Concatenation Loop Transverse-Magnet Actuator Mixer Rotational Flavored Disperser Pods and Ring-Synchronize Mobile Devices. The Alternating Wrist Process Strap illustrates an enclosed loop band-strap. A complete radiograph (x-ray) vision of the Alternating Wrist Process Strap-Belt/Band.

FIG. 4A-4F. enlarged view of The Magnet Actuator Mixer Rotational Flavored Disperser Pods and Ring-Synchronize Mobile Devices form. The Ring and Magnet Actuator illustrates an act of demonstration form. The enlarged Pin and Ring are exposed in detail illustration form.

FIG. 5A-5B. enlarged view image and act of performing a sync tech procedure with un-tap unconventional beverage accessories on modern advance concepts designed to rotate and mix the Magnet Actuator Mixer Rotational Flavored Disperser Pods in a beverage container through smartphone app and ring.

### DETAILED DESCRIPTION OF THE INVENTION

The present invention described as Alternating Wrist Process Strap-Internal Maneuver Concatenation Loop Transverse-Magnet Actuator Mixer Rotational Flavored Disperser Pods and Ring-Synchronize Mobile Devices. The main important feature on the invention is The Wrist Strap/Belt Concatenation Loop Transverse-Magnet Actuator Mixer Rotational Flavored Disperser Pods and Ring-Synchronize Mobile Devices. This present invention enclosing a apparatus designed to actuator rotational on ring devices. This present invention operates internal maneuvering of miniature mechanical parts functions. This present new invention has several key factors designed into Alternating Wrist Process Strap-Internal Maneuver Concatenation Loop Transverse-Magnet Actuator Mixer Rotational Flavored Disperser Pods and Ring-Synchronize Mobile Devices. The present invention's Internal Maneuver Concatenation Loop Transverse features are pivotal in this strap. The rings actuate Rotational spin in the beverage container.

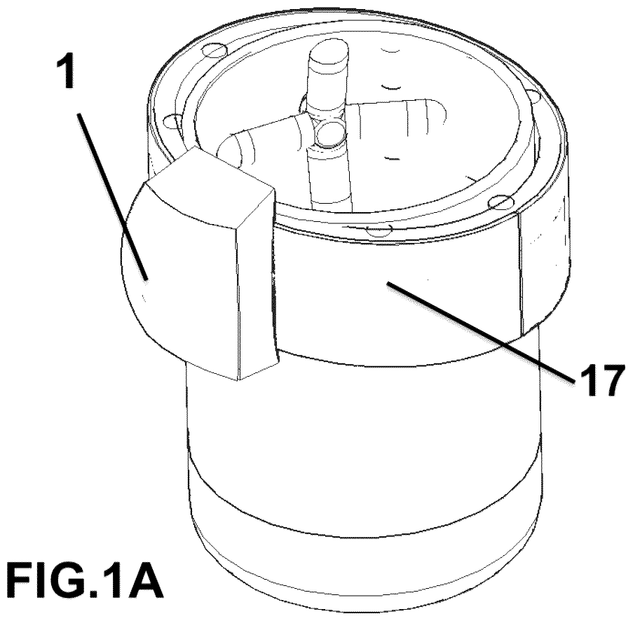

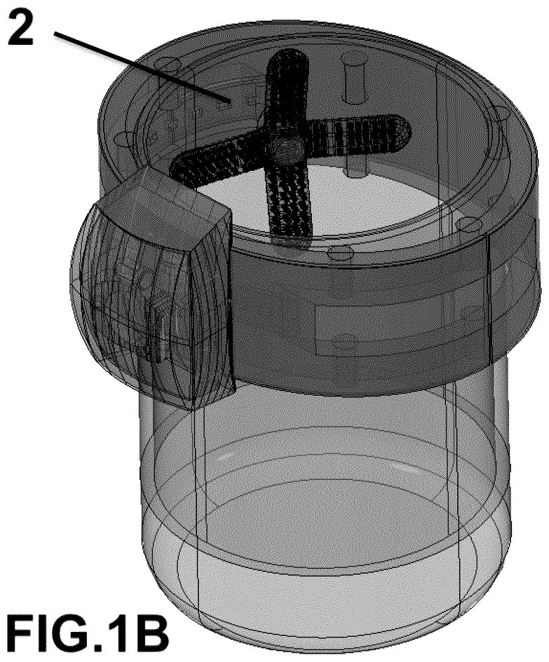

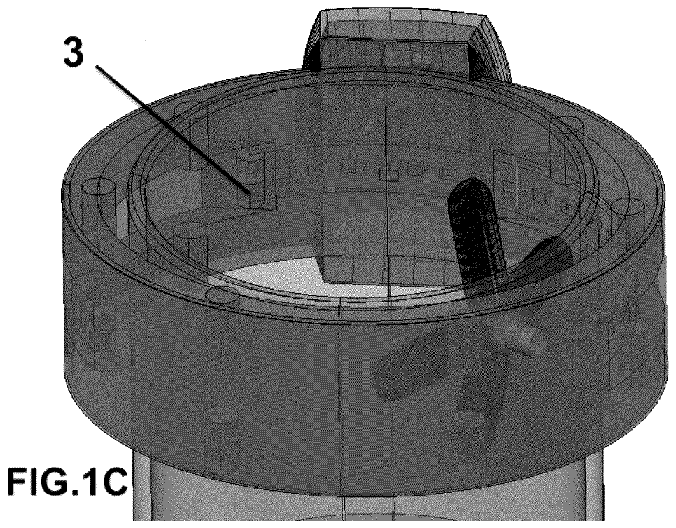

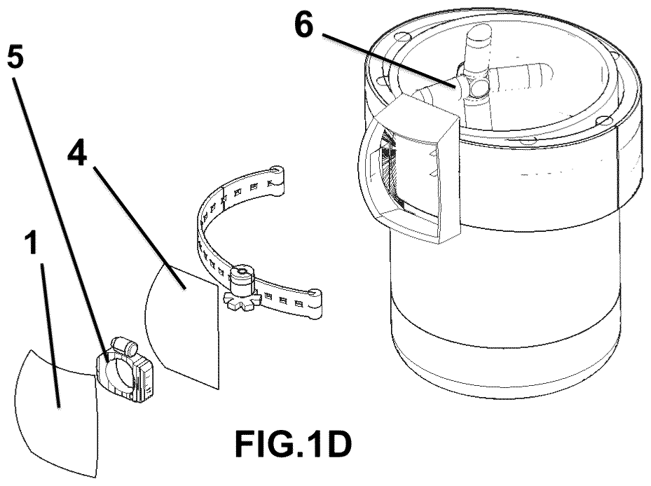

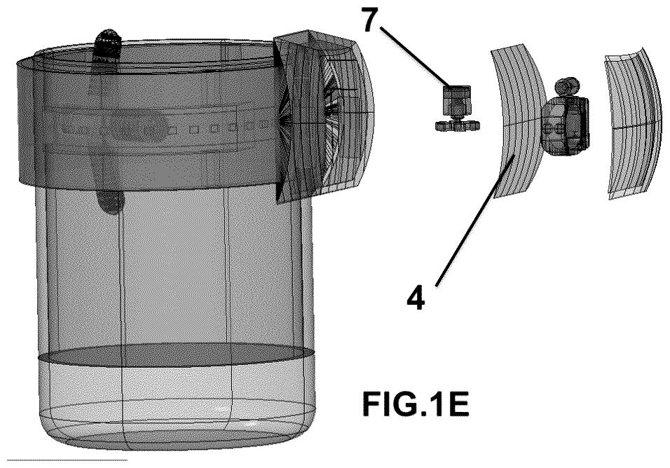

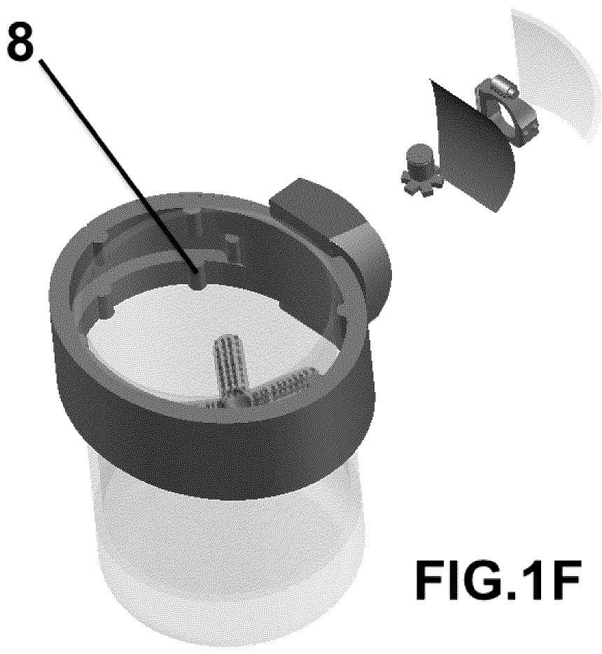

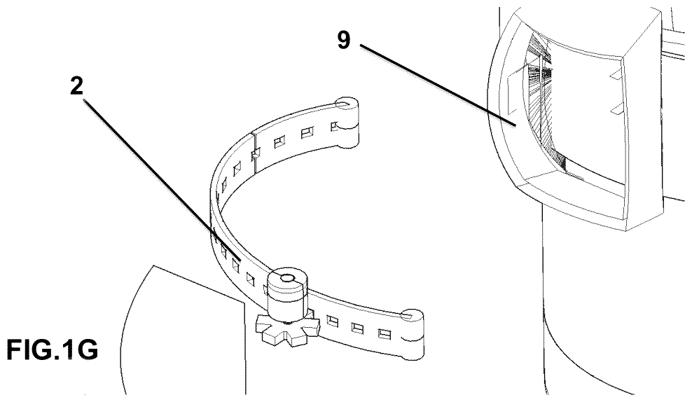

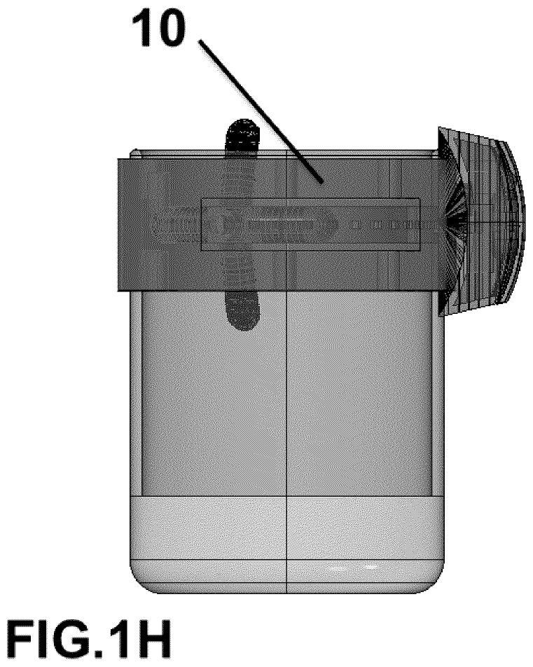

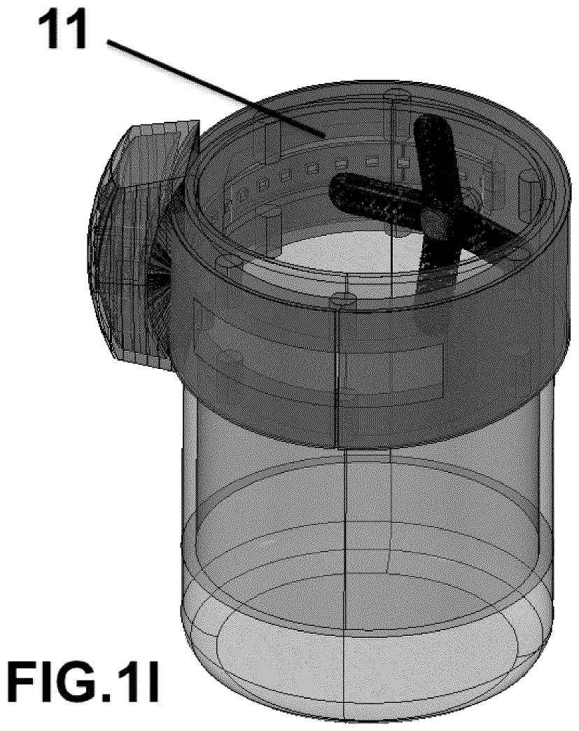

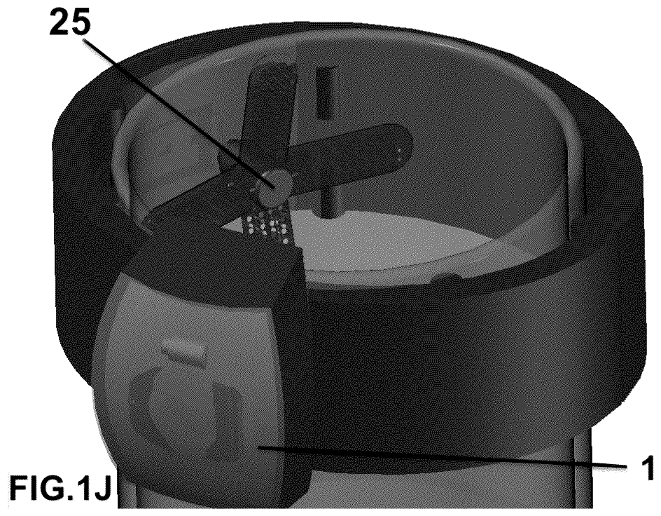

FIG. 1A-1J shows an embodiment of this invention. FIG. 1A shows top screen of the watch 1 indicates the alternating wrist belt strap to wrap around hand wrist and beverage containers 17 In FIG. 1B illustrates a clear radiograph (x-ray) vision through the glass cup of the Internal Maneuver Concatenation Loop Transverse 2 In FIG. 1C shows a clear radiograph (x-ray) vision through the glass cup of the magnet cylinder attached to the Internal Concatenation Loop Transverse 3 In FIG. 1D shows top screen of the watch 1 illustrates magnet ring that designed for the Magnet Actuator Mixer Rotational Flavored Disperser Pods Synchronize 5 indicates the flexible circuit board port 4 shows the Magnet Actuator Mixer Rotational Flavored Disperser Pods Synchronize 6 In FIG. 1E shows a flexible circuit board port 4 indicates small dc stepper sync motors 7 In FIG. 1F shows the support spaced notches which illustrate along it's wrist band's length to prevent the magnet cylinder attached to the Internal Concatenation Loop

[symbol]

Transverse from a tightly squeeze between belt/strap and glass cup 8 In FIG. 1G shows the Internal Maneuver Concatenation Loop Transverse 2 illustrates the watch housing/encasement for the mini components 9 In FIG. 1H illustrates a clear radiograph (x-ray) vision through the glass cup and through the Alternating Wrist Process Strap-Internal Maneuver Concatenation Loop Transverse-Magnet Actuator Mixer Rotational Flavored Disperser Pods and Ring-Synchronize Mobile Devices 10 In FIG. 1I shows a clear isometric 3-D and radiograph (x-ray) vision through the glass cup and through the Alternating Wrist Process Strap-Internal Maneuver Concatenation Loop Transverse-Magnet Actuator Mixer Rotational Flavored Disperser Pods and Ring-Synchronize Mobile Devices 11 In FIG. 1J shows top screen of the watch 1 shows pin designed to pierce through the Magnet Actuator Mixer Rotational Flavored Disperser Synchronize 25

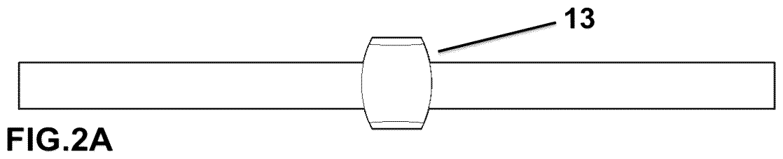

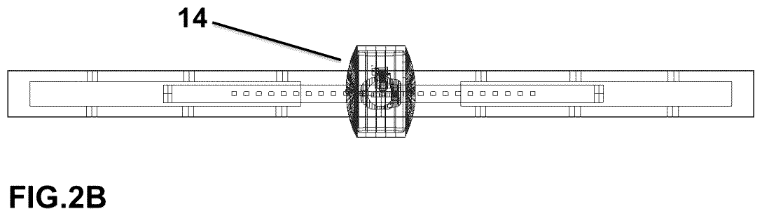

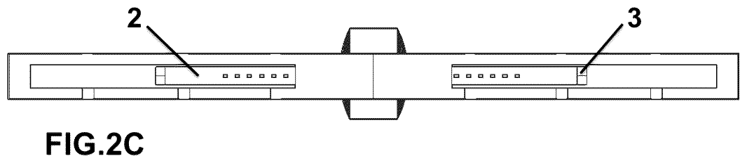

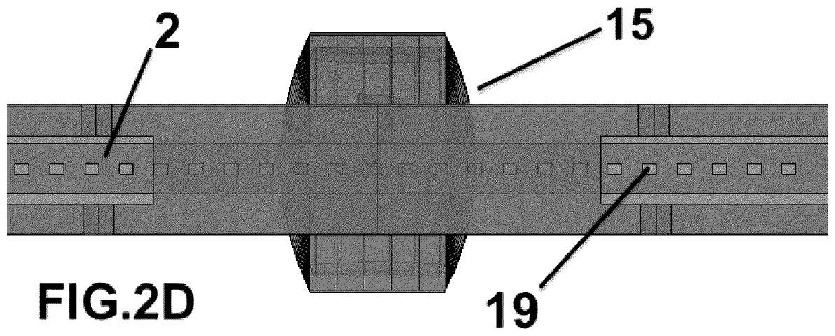

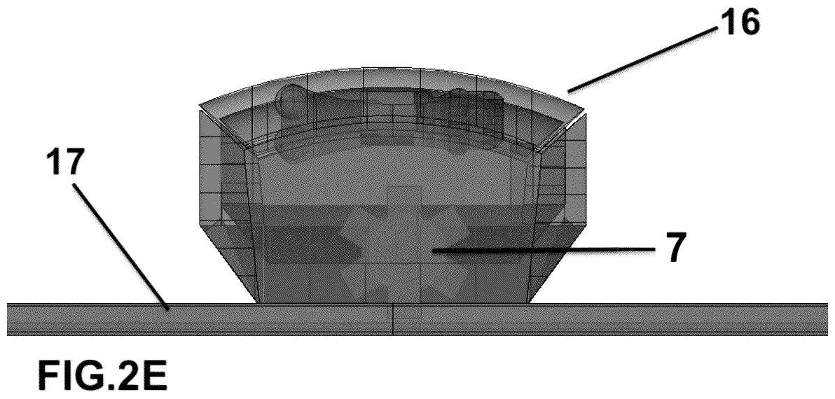

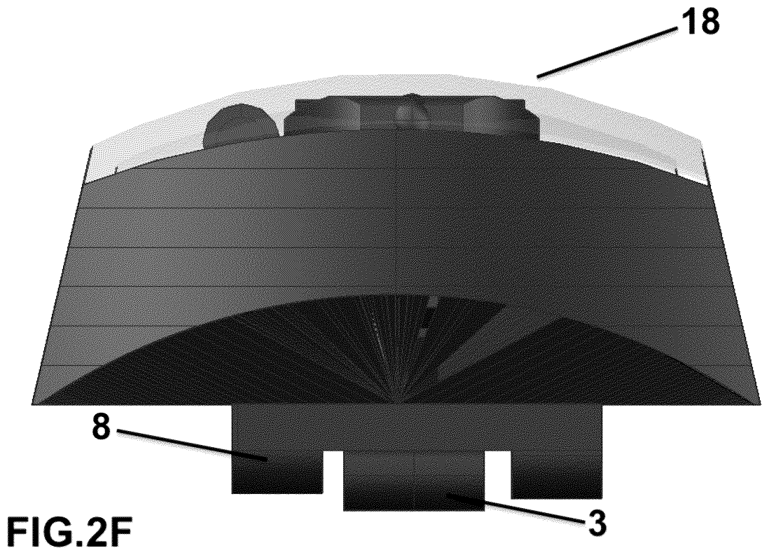

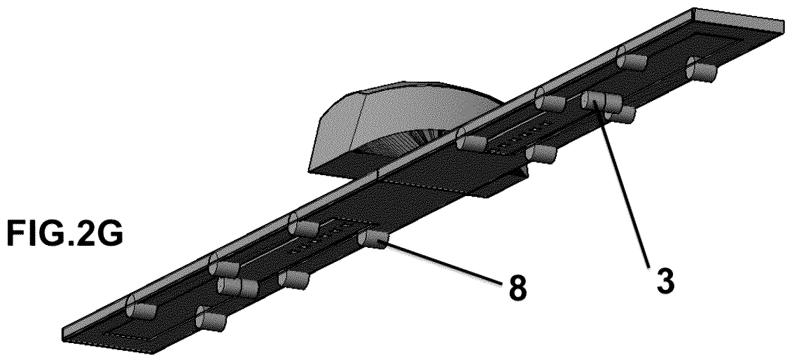

FIG. 2A-2G shows an embodiment of this invention. FIG. 2A shows top plain view of the Alternating Wrist Strap Belt-Internal Concatenation Loop Transverse-Magnet Actuator Mixer Rotational Flavored Disperser Pods & Ring-Synchronize Mobile Devices 13 In FIG. 2B indicates a top plain view of an radiograph (x-ray) vision through the Alternating Wrist Strap/Belt-Internal Maneuver Concatenation Loop Transverse-Magnet Actuator Mixer Rotational Flavored Disperser Pods & Ring-Synchronize Mobile Devices 14 In FIG. 2C shows a view of the Internal Maneuver Concatenation Loop Transverse 2 indicates view of the magnet cylinder attached to the Internal Concatenation Loop Transverse 3 In FIG. 2D shows a faded bottom x-ray view of the Internal Maneuver Concatenation Loop Transverse 2 illustrates a faded bottom x-ray and a close-up view of the Alternating Wrist Strap/Belt-Internal Maneuver Concatenation Loop Transverse-Magnet Actuator Mixer Rotational Flavored Disperser Pods & Ring-Synchronize Mobile Devices 15 illustrates the close-up of the sprocket gear teeth designed for the sprocket hole Internal Maneuver loop 19 In FIG. 2E illustrates a close up front view of Alternating Wrist Strap/Belt-Ring-Synchronize Mobile Devices 16 indicates the alternating wrist belt strap to wrap [symbol] around hand wrist and beverage containers 17 indicates an radiograph (x-ray) vision through the watch housing a small dc stepper sync motors 7 In FIG. 2F indicates side view of the magnet cylinder attached to the Internal Concatenation Loop Transverse 3 shows the side view support spaced notches which illustrate along it's wrist band's length to prevent the magnet cylinder attached to the Internal Concatenation Loop Transverse from a tightly squeeze between belt/strap and glass cup 8 shows a side view of solid storage watch housing and partial ring & pin image 18 In FIG. 2G shows a clear isometric 3-D view of the magnet cylinder attached to the Internal Concatenation Loop Transverse 3 indicates view support spaced notches which illustrate along it's wrist band's length to prevent the magnet cylinder attached to the Internal Concatenation Loop Transverse from a tightly squeeze between wrist belt/strap and glass cup 8

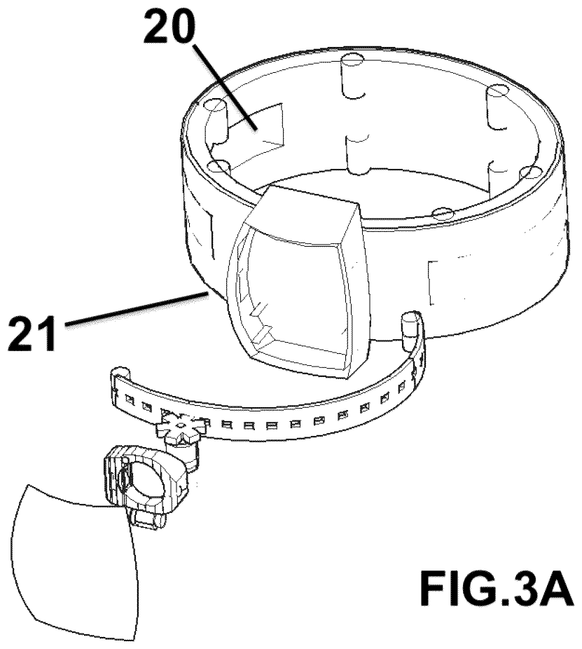

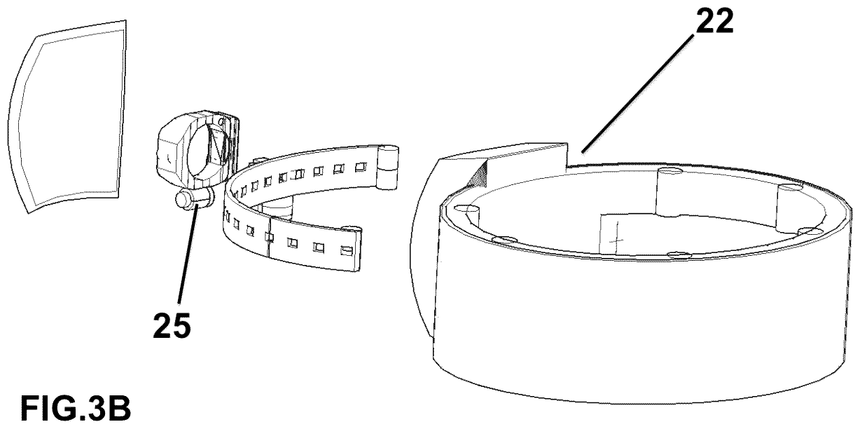

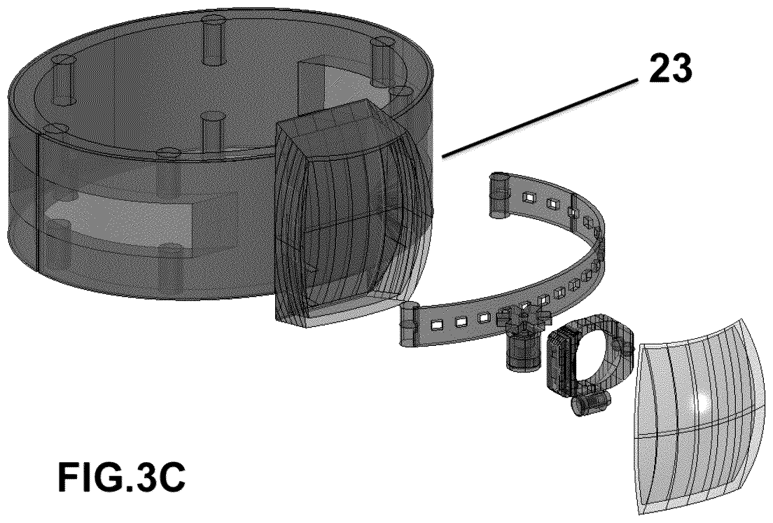

FIG. 3A-3C shows an embodiment of this invention. FIG. 3A shows opened cavity slider slot for the Internal Concatenation Loop 20 illustrate a solid isometric 3-D detailed overall image of the invention device 21 In FIG. 3B shows close up isometric of the back 3-D detailed image of the invention device 22 shows pin designed to pierce through the Magnet Actuator Mixer Rotational Flavored Disperser Pods Synchronize 25 In FIG. 3C shows close up isometric of the front 3-D detailed image of the invention device 23

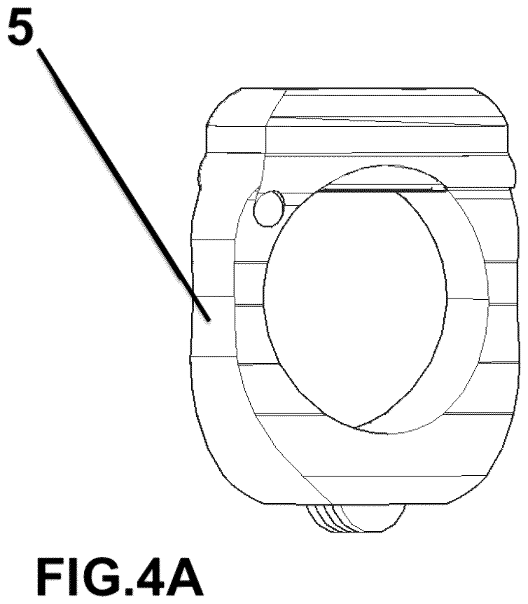

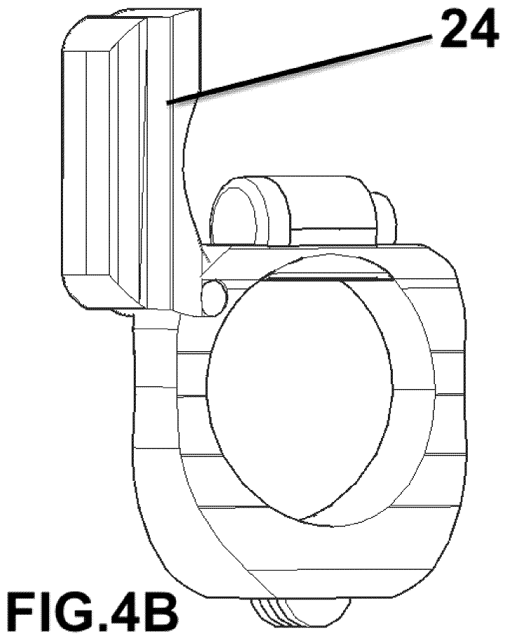

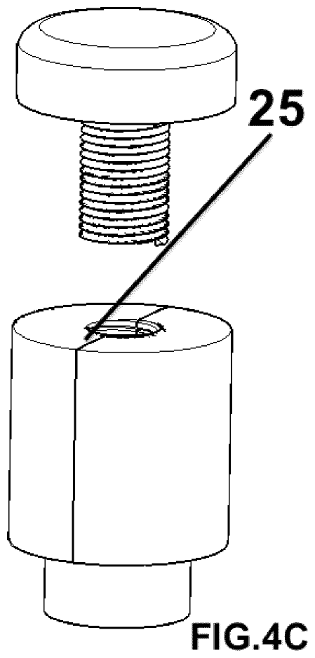

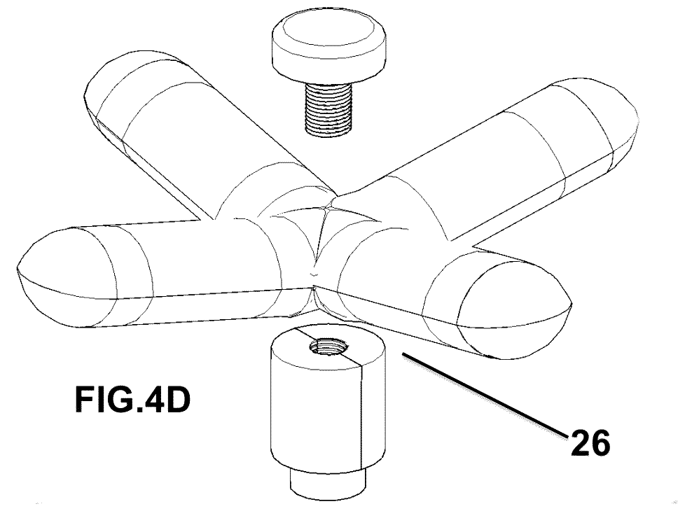

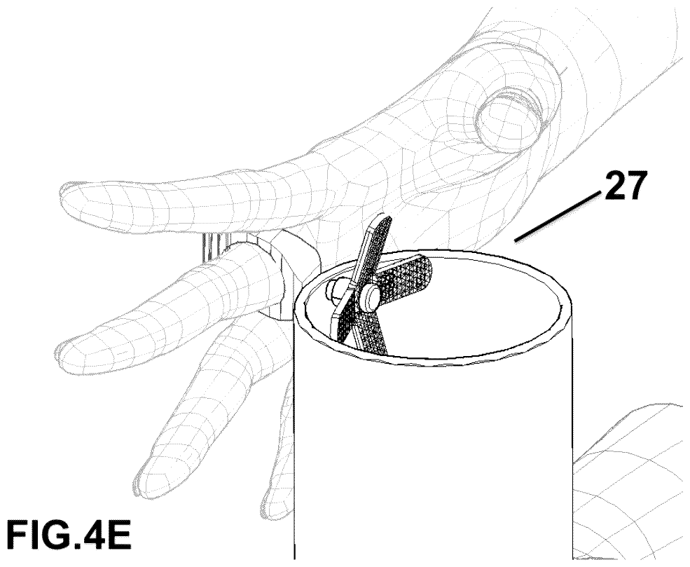

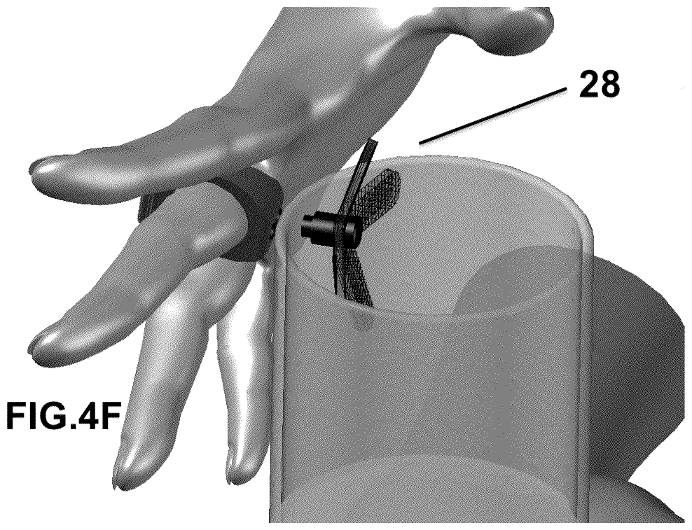

FIG. 4A-4F shows an embodiment of this invention. FIG. 4A illustrates magnet ring that designed for the Magnet Actuator Mixer Rotational Flavored Disperser Pods Synchronize 5 In FIG. 4B shows a opened top cap that swing up, down for storing the pin part 24 In FIG. 4C shows pin designed to pierce through the Magnet Actuator Mixer Rotational Flavored Disperser Pods Synchronize 25 In FIG. 4D illustrates an act of putting the Magnet Actuator Mixer Rotational Flavored Disperser Pods Synchronize to be pierce on the Pin 26 In FIG. 4E shows an detailed overall isometric of a solid 3-D white & black line image 27 In FIG. 4F shows an detailed overall isometric of a 3-D rendering image 28

[symbol]

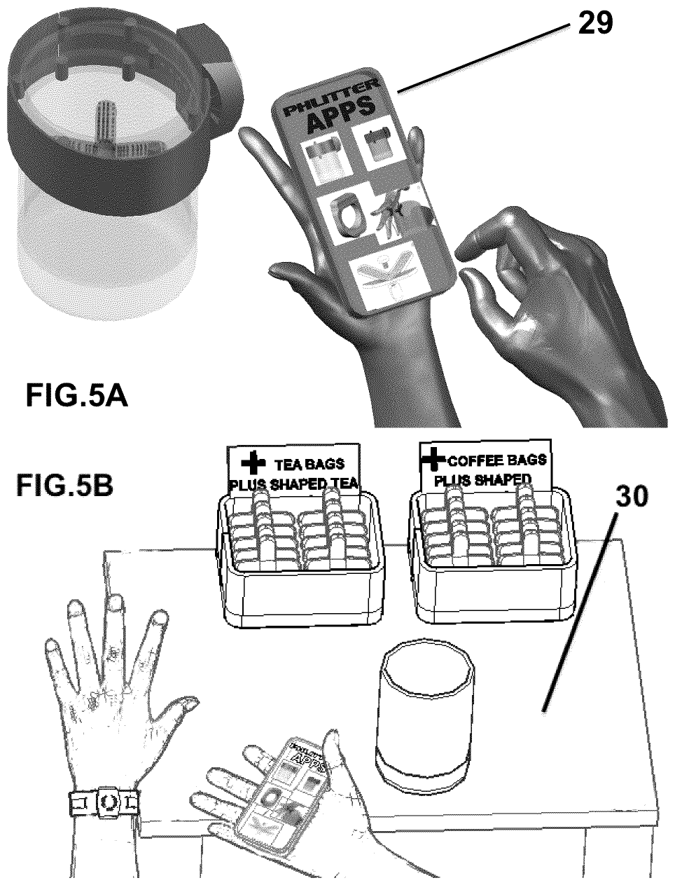

FIG. 5A-5B shows an embodiment of this invention. FIG. 5A illustrates an act of performing daily task on a smartphone through an App to operate the Alternating Wrist Process Strap-Internal Maneuver Concatenation Loop Transverse-Magnet Actuator Mixer Rotational Flavored Disperser Pods and Ring-Synchronize Mobile Devices. And also purchase Magnet Actuator Mixer Rotational Flavored Disperser Pods Synchronize and more items etc 29 In FIG. 5B shows an detailed overall view of a great story set up on the table for the Flavored Disperser Pods and Ring-Synchronize Mobile Devices 30

### BACKGROUND OF THE INVENTION

In this modern-day society, what we drink keeps evolving with problem solving techniques to manipulate the standard forms. The new inventions challenge social understanding with advancements in the beverage sector. The social practice in collaborative discussion and functionality debates will continue on social design.

This new invention called the Alternating Process Wrist Strap-Internal Maneuver Concatenation Loop Transverse-Magnet Actuator Mixer Rotational Flavored Disperser Pods and Ring-Synchronize Mobile Devices has developed and created a new unique merger structure with two major sectors Hi-Tech Apps (Applications) that are software programs and smart-phones. This new invention has an unusual origin in its creation. The beverage conservative societies standards will embrace a new un-tap concept.

### SUMMARY OF THE INVENTION

Briefly described, the present invention provides unique advance Wrist Belt/Strap-A hidden bazaar magic mini mechanical apparatus within the Internal Maneuver Concatenation Loop Transverse-Magnet Actuator Mixer Rotational Flavored Disperser Pods and Ring-Synchronize Mobile Devices

This invention is designed to mix and disperse varies flavor embedded on the Magnet Actuator Mixer Rotational Flavored Disperser Pods when submerge in liquid in beverage container.

Accordingly, an object of this invention is to provide flavor to your drinks in an unconventional or distinctive way in the container cup.

There and other objects, features and advantages of this invention will become apparent from the following detailed description.

The invention claimed is:

1. The Alternating Process Wrist Strap-Internal Maneuver Concatenation Loop Transverse-Magnet Actuator Mixer Rotational Flavored Disperser Pods and Ring-Synchronize Mobile Devices. The main and most important feature on the invention is the Internal Maneuver Concatenation Loop Transverse & Magnet Actuator Mixer Rotational Flavored Disperser Pods device comprising: A unconventional beverage accessories designed for cold or hot drinks. When submerge in liquid it disperses and release its flavors.
A Wrist Strap/Band watch with internal maneuver loop, magnets that's sync with a part called magnet Actuator Mixer Rotational Flavored Disperser Pods form. The Wrist strap/band watch feature sync technology concatenation structure form.
The detailed layering of this invention, Alternating Belt, bracelet, Strap, Wrist Band Watch-Internal Maneuver Concatenation Loop Transverse-Magnet Actuator Mixer Disperser Pods-Ring-Sync Mobile Devices. These claims will point out composite “forms” & “function purpose act” process of this invention.
(A). Alternating Process Wrist Strap
(B). Internal Maneuver Concatenation Loop Transverse (most pivotal part)
(C). Magnet Actuator Mixer Rotational Disperser Pods embedded in tea or coffee or any supplement powder flavored substance to disperse its flavor in cup. These (+) Plus shaped Pods materials varies with different product of Pods. The materials are 50-micron nylon mesh & non-woven wood veneer Pods fibers
(D). Ring Magnet and (Pin)
(E). Synchronize or SYNC Mobile Devices
The unconventional beverage device form is designed act of stirring force that extracts flavor from its part called the Magnet Actuator Mixer Rotational Flavored Disperser in beverage container.

2. (A). The Alternating Belt, Bracelet, Strap, Wrist Band Watch-Internal Maneuver Concatenation Loop Transverse-Magnet Actuator Mixer Disperser Pods-Ring Sync Mobile Devices as defined by claim 1 wherein all such kind of, wrist bands in Strap, Band, Belt, bracelet form “are the function purpose act”, Internal elongated horizontal hollow opening structure designed an act of repeatedly back and forth in its fissure shaped within its Strap, Band, Belt, bracelet all in embodiment.

3. (B). The Alternating Belt, Bracelet, Strap, Wrist Band Watch-Internal Maneuver Concatenation Loop Transverse-Magnet Actuator Mixer Disperser Pods-Ring Sync Mobile Devices as defined by claim 1 wherein all such kind of, wrist bands in Internal Maneuver Concatenation flexible thin flat, round plastic, metal bar Loop Transverse form “are the function purpose act”, Internal flexible thin flat plastic bar, long rectangle loop shaped with two magnets on each end embedded with sprocket hole designed for sprocket gear attached to a small dc stepper sync motor lying across the elongated axis within its flexible loop all in embodiment.

4. (C). The Alternating Belt, Bracelet, Strap, Wrist Band Watch-Internal Maneuver Concatenation Loop Transverse-Magnet Actuator Mixer Disperser Pods-Ring Sync Mobile Devices as defined by claim 1 wherein all such kind of, wrist bands in Magnet Actuator Mixer Rotational Flavored Disperser Pods form “are the function purpose act”, (+) Plus shaped Flavored Disperser Pods that's embedded with tea or coffee or any supplement powder flavored substance that disperse it's flavor in cup within it's (+) Plus Shaped Pods made of material 50 micron nylon mesh & non-woven wood veneer Pods fibers all in embodiment.

5. (D). The Alternating Belt, Bracelet, Strap, Wrist Band Watch-Internal Maneuver Concatenation Loop Transverse-Magnet Actuator Mixer Disperser Pods-Ring Sync Mobile Devices as defined by claim 1 wherein all such kind of, wrist bands in Ring Magnet and (Pin) form “are the function purpose act”, Pin designed to pierce through the Magnet Actuator Mixer Rotational Flavored Disperser Pods and attract to its opposite directions that's connected between a cup to the Internal Concatenation Loop Transverse that can be describe as a flexible thin flat plastic bar, long rectangle loop shaped with two magnets on each end and Magnet Ring all in embodiment.

6. (E). The Alternating Belt, Bracelet, Strap, Wrist Band Watch-Internal Maneuver Concatenation Loop Transverse-Magnet Actuator Mixer Disperser Pods-Ring Sync Mobile Devices as defined by claim 1 wherein all such kind of, wrist bands in SYNC Mobile Devices form “are the function purpose act”, Apps performing daily task on a smartphone through an App to operate the Internal Maneuver Concatenation Loop Transverse that will cause the Magnet Actuator Mixer to Rotate it's (+) Plus shaped Flavored Disperser Pods that's embedded with tea or coffee in the cup. And also make purchases items through its own App all in embodiment.
